(19) United States
(12) Patent Application Publication
(10) Pub. No.: US 2016/0279873 A1
(43) Pub. Date: Sep. 29, 2016

(54) ADDITIVE LAYER MANUFACTURING METHOD AND APPARATUS FOR THE MANUFACTURE OF A THREE-DIMENSIONAL FIBER-REINFORCED OBJECT

(71) Applicant: Airbus Operations GmbH, Hamburg (DE)

(72) Inventors: Marc Fette, Hamburg (DE); Johannes Born, Hamburg (DE)

(21) Appl. No.: 15/080,081

(22) Filed: Mar. 24, 2016

(30) Foreign Application Priority Data
Mar. 27, 2015 (DE) 10 2015 104 827.2

(51) Int. Cl. B29C 67/00

(52) U.S. Cl. CPC B29C 67/0077; B33Y 10/00

(57) ABSTRACT

Method and apparatus of manufacturing a three-dimensional fiber-reinforced object by additive layer manufacturing, including providing layers of powder material, one on top of the other, on a support device, and selectively irradiating each layer with a laser beam or particle beam prior to providing the successive layer only in those areas corresponding to the object to be manufactured. Irradiation occurs where the powder material is locally molten or sintered in respective areas for solidifying the layer. Fibers are provided to the support device or in one of the layers in the course of solidification and held by a fiber holding arrangement. Each layer is provided by spraying the powder material by a spray head, and the support device is electrically charged and/or the powder material is electrically charged in the spray head prior to spraying, the powder material being electrically attracted to the support device.

### CROSS-REFERENCE TO RELATED APPLICATION

This application claims priority to German Patent Application No. 10 2015 104 827.2 filed Mar. 27, 2015, the entire disclosure of which is incorporated by reference herein.

### TECHNICAL FIELD

The present disclosure relates to an additive layer manufacturing method for the production of a three-dimensional fiber-reinforced object and to a corresponding apparatus for the production of a three-dimensional fiber-reinforced object by an additive layer manufacturing method.

### BACKGROUND

Additive layer manufacturing methods are increasingly used to very quickly produce prototypes or finished components. Unlike conventional production methods, which involve the removal of material from a block of material by, for example, milling, cutting, drilling or other processing methods, additive layer manufacturing methods build a desired three-dimensional object directly, layer by layer, on the basis of a digital description or representation of the object. These methods are also known as 3D printing or rapid prototyping.

In a typical additive layer manufacturing method, a thin layer of material from which the object is to be produced is initially applied in powder form to a support plate, and the powder of the just applied layer is melted or sintered by laser irradiation selectively only in those areas of the layer that correspond to the object to be produced. Subsequently, another thin layer of the material is applied in powder form on top of the thus processed first layer and, in turn, melted or sintered by laser irradiation selectively only in those areas of the layer that correspond to the object to be produced. This step is repeated until the entire object has been produced. In each step, the powder not corresponding to the object is not irradiated and remains in powder form, so that it can be removed from the finished object at a later time. The support plate can be provided in the form of a movable table which, after each irradiation of a layer, is lowered by an interval or distance equal to the thickness of this layer, in order to ensure identical initial conditions prior to the application of each layer.

In this regard it is to be noted that it is in principle also possible that the individual layers are not continuous layers or layers that fully cover the support plate, but rather have material only in those areas that correspond to the object to be produced, or in areas that comprise those areas that correspond to the object to be produced.

Particular additive layer manufacturing methods are the so-called selective laser melting (SLM) and the so-called selective laser sintering (SLS), in which a laser beam is used to irradiate the layers as described above. However, it is also possible to use a particle beam for this purpose and, in particular, an electron beam. Particular additive layer manufacturing methods utilizing an electron beam are, in accordance with the two afore-mentioned methods, the so-called selective electron beam melting and the so-called selective electron beam sintering.

As explained above, the object is built directly, layer by layer, in a three-dimensional manner. This makes it possible to produce various highly complex objects in one and the same apparatus efficiently and rapidly from a variety of materials, in particular from metal, but also from plastics and ceramic materials. For example, extremely complex lattice or honeycomb structures can be easily produced that cannot be produced or can only be produced with great difficulty using other methods. Compared with traditional production methods, the complexity of the object has only a minor impact on the production costs.

With additive layer manufacturing methods like those mentioned above it is difficult, however, to produce objects with specifically adjusted or set material properties. For example, it is difficult to produce fiber-reinforced objects with reliably reproducible properties, amongst other things because the presence of the fibers makes conventional layer application methods, such as those using rollers or spreading knives, impossible or at least very complicated.

### SUMMARY

It is an object of the disclosure herein to provide a method and an apparatus for the production of a three-dimensional fiber-reinforced object, by which a three-dimensional fiber-reinforced object can be produced in a simple, rapid and cost-efficient manner.

This object is achieved by a method and apparatus having the features described herein. Advantageous embodiments of the method and the apparatus are also described herein.

According to the present disclosure, an additive layer manufacturing method for the production or manufacture of a three-dimensional fiber-reinforced object is provided, in which a plurality of layers of a powder material are applied successively and one on top of the other, in the manner already explained above, onto a support device or means, which can, in particular, comprise a flat or planar platform or a flat or planar table, and each layer is irradiated, before the application of the subsequent layer, by a laser beam or a particle beam selectively only in the areas of the layer that correspond to the three-dimensional object to be produced. The layers can typically have layer thicknesses in a range from 20 to 100 μm, with the layer thicknesses being selected on the basis of the desired surface quality and the desired processing speed.

The irradiation is carried out in such a manner that the powder material is locally molten or sintered in the corresponding areas. In this manner, the powder particles are connected in the irradiated areas and with the previous layer. The three-dimensional object can, for example, preferably be an aircraft component.

Further, a plurality of fibers is provided, which are embedded in the matrix provided by the powder material in the manner described in the following. Each of the fibers is fixed with one end, prior to the application of the first layer or after the application of a portion (i.e. a partial quantity or a number) of the layers, to the support device or in one of the layers during its solidification. In other words, the corresponding end is attached to the support device separately from the object to be produced or is attached in the object itself. In the former case, the attachment can take place before the application of the first layer, but in principle it can also take place only once some of the layers have already been applied and irradiated. In the latter case, the attachment of the end takes place either in the first layer or in a subsequent layer. The attachment is chosen, on the one hand, according to the areas of the object through which the respective fiber is to extend and/or in which direction it is to do so. The choice is also made based on practical considerations. An attachment to the support device may be simpler to accomplish, however it necessitates a suitable attachment device on the support device. An attachment in a layer of the object, however, necessitates no such separate attachment device. It is possible for the ends of different fibers to be attached differently, i.e. in different layers of the object, or some ends in layers and others at the support device, for example.

Each of the fibers fixed at one end is held by a fiber holding arrangement or means or fiber retaining arrangement or means, which can comprise several separate holding or retaining devices for individual fibers or individual groups of fibers, in such a way that, at least in a portion or segment extending or starting from the fixed end, the respective fiber extends, preferably under tension, through a space region in which one or more of the subsequent layers are applied or provided and which corresponds to the three-dimensional object to be produced. The fiber holding arrangement, which is preferably wholly or partially movable relative to the support device, can be arranged or can be positioned such that all fibers extend parallel or such that different fibers or different groups of fibers have a different path, extension or orientation. For example, a fiber mesh can also be provided, or a targeted adjustment or adaptation of the path, extension or orientation of the fibers according to the desired properties of the object can be carried out. Such different paths, extensions or orientations can be facilitated by attaching, in the manner already mentioned, the ends of different fibers differently to the support device or in a layer.

If the fiber holding arrangement is wholly or partially movable relative to the support device, it is also advantageously possible to change the path, extension or orientation of individual or of all fibers after the irradiation of each layer, so that the fibers extend through the subsequent layer in a different direction. In other words, the fiber path, extension or orientation along each fiber can be changed from layer to layer, to adapt it to the desired local properties of the object to be produced.

In order to easily obtain a uniform, precise and reproducible layer application, despite the presence of the fibers and with no disadvantageous restrictions with regard to the positioning of the fiber holding arrangement and the realizable fiber paths, extensions or orientations, each of the layers is applied by spraying the powder material by at least one spray head. In addition, the support device—and by that means preferably also the already applied and solidified layers—are electrically charged, i.e. placed at an electrical potential. For example, with the aid of a suitable charging device or means, a high electrical potential can be applied directly to the support device or an electrically conductive part of the support device, or the support device can be electrostatically charged—e.g. with a suitable high-voltage electrode arrangement and a high voltage source. Alternatively to the charging of the support device or additionally to the charging of the support device, it can also be provided that the powder material is electrically or electrostatically charged in the at least one spray head prior to the spraying. For this purpose, the at least one spray head then comprises a suitable device or arrangement, such as e.g. a high voltage electrode, which is connected to a suitable high voltage source. In any case, the charging of the support device and/or of the powder material has the result, or the charging is realized in such a manner, that there is an electrical attraction between the powder material and the support device and thus the sprayed powder material is electrically attracted by the support device.

It has been found that a uniform layer application can be realized in this way in a very simple and reliable manner, and this, in particular, with the possibility of obtaining a targeted choice of fiber path, extension or orientation. It is thus possible to produce, very flexibly and in a time-and cost-saving manner, components having very different shapes and a high level of complexity with selectively or specifically adjustable properties. Furthermore, unlike known methods, it is not necessary to move the support device after the application of each layer in order to obtain for the subsequent layer a defined position of the surface onto which the subsequent layer is applied.

In a preferred embodiment, the support device is electrically charged again or recharged prior to each application of a layer. In addition, the support device is fully or at least partially discharged after each application and the solidification of a layer, or preferably after each application but prior to solidification of the layer. For this purpose, in particular a charging device for the support device can be provided that is adapted to optionally or selectively put the support device to ground potential, i.e. to apply ground potential to the support device. It is easily possible in this manner to remove, after the solidification of each layer, the excess powder material of this layer. In the case of discharging prior to the solidification it is also possible to take other measures, if appropriate, in order to obtain an even more uniform distribution of the powder material and, in particular, an even more uniform layer thickness.

For example, in a preferred embodiment, the support device is shaken or put into vibration or vibrated subsequent to each application of a layer and prior to its solidification, preferably subsequent to a partial or full discharge of the support device. In this regard, the support device is preferably shaken or set to vibrate with a frequency from the ultrasonic range. By such high frequencies, the desired mere improvement of the uniformity can be achieved particularly effectively and simply. In any case, the support device can have a shaking or vibrating device or can be arranged on a shaking or vibrating device or coupled thereto.

In a preferred embodiment, the powder material is sprayed using two or more spray heads from different directions relative to the support device, with the spray heads preferably being arranged at a distance from one another. In other words, the powder material is applied from different directions or from different sides, which makes it possible to obtain an even more uniform application, in particular taking into account the presence of the fibers. The multiple spray heads are preferably arranged symmetrically relative to the support device.

In a preferred embodiment, upon each application of a layer, the layer thickness is optically monitored, preferably with spatial resolution over the extension of the layer. On the basis of the monitoring, the application is controlled such that a predetermined layer thickness is obtained, and this preferably uniformly over the entire extension of the layer. In particular, it may be provided that, on the basis of the optical monitoring, another discharge of powder material through the spray head or all or some of the spray heads occurs, and/or that the support device is shaken or set to vibrate in the manner described above. In this regard, a suitable optical measurement device can advantageously be provided, which is connected, for example, to a control device that receives a measurement result of the optical measurement device and, on the basis of the measurement result, automatically controls the spray heads and/or a shaking device in such a way that the desired layer thickness is uniformly obtained. For this purpose, it can also be advantageous that the control device also controls a charging device of the type described above on the basis of the measurement result.

In a preferred embodiment, the support device is electrically charged differently in different areas, so that a different application of the powder material occurs in the different areas. This makes it particularly easy to obtain different layer thicknesses in different areas.

In a preferred embodiment, the spatial orientation of the support device is changed such that, during the application of different layers, it has at least two different orientations. Alternatively or additionally, it can be envisaged that the fiber holder and/or the at least one spray head is moved relative to the support device so that, during the application of different layers, they have at least two different positions relative to the support device. In this manner, a particularly flexible and simple production of three-dimensional objects having complex geometries is possible due to the application of the powder material by electrical attractive forces.

In a preferred embodiment, the selective irradiation of each layer is carried out from different directions by several laser or particle beams. This makes it possible to easily and reliably avoid shadowing effects from the fibers, and a higher production speed can be obtained.

The fibers can advantageously be, or include, glass fibers, aramid fibers, carbon fibers, ceramic fibers and/or metal fibers. The powder material can advantageously be, or include, powder from a metal or a metal alloy, such as steel, aluminum, titanium or corresponding alloys, powder from a plastic material, powder from a ceramic material and/or powder from a glass material.

With the method described above it is also advantageously possible to produce three-dimensional objects, which comprise different materials in different areas or regions. In particular, it is possible to produce fiber-reinforced metal-plastic hybrid components, with the plastic being a thermoplastic material. In this regard, other powder materials can be simply used, for example, from one layer to another, wherein the electrical charging of the support device and/or powder material can be advantageously adjusted to the respective powder material. Moreover it is, for example, additionally or alternatively possible to provide within a layer areas or regions made of different powder material. The already mentioned locally different charging of the support device can be employed in this context.

However, for the production of fiber-reinforced metal-plastic hybrid components it is particularly advantageous that, due to the higher melting point of metals compared with thermoplastic materials, initially a metal segment of the object is produced in the described manner and then plastic is applied in the described manner directly to the already finished metal segment in order to complete the object. In this regard too, the electrical attraction permits for a particularly easy uniform and targeted application of the plastic powder material to the metal segment.

In this regard it should be noted that such metal-plastic hybrid components may also be produced non-fiber-reinforced in the described manner by simply omitting the fibers. Furthermore, it is alternatively also possible to use non-thermoplastic materials such as in particular duromers and to produce the plastic segment of the object for example by fused deposition modeling or alternatively stereolithography. Even in the case of stereolithography it can be advantageous—as described above—to use shaking or vibration in order to obtain an even more uniform layer distribution.

The method described above can advantageously be carried out by an apparatus that comprises a support device, a powder material feeding device, an irradiation device or arrangement, a charging device or arrangement, a storage device and a control device, which have already been partially described above.

The powder material feeding device includes the at least one spray head for spraying the powder material and is adapted to apply the plurality of layers of a powder material to the support device in the described manner.

The irradiation device is adapted for irradiating each layer applied by the powder material feeding device, prior to the application of the subsequent layer, selectively and by areas, using at least one laser beam or particle beam, and for this purpose it comprises, for example, at least one laser device and/or at least one electron beam device. The irradiation device also preferably comprises a beam movement device, to move each laser beam or particle beam that is used over the support device and thus to selectively irradiate only selected areas of the layers. In principle, however, it is also possible that the support device is moved relative to a stationary irradiation device or a fixed laser beam or particle beam.

The charging device already described above is adapted to selectively electrically charge the support device and preferably also to selectively discharge it.

The storage device is adapted for storing a digital representation of a three-dimensional object in the form of a plurality of layers.

The control device is coupled to the powder material feeding device, the irradiation device and the charging device and is adapted to control these such that a three-dimensional object, which corresponds to a digital representation of the object stored in the storage device, is produced according to the method described in detail above, i.e., amongst other things, to control the charging and, if appropriate, discharging of the support device by the charging device, the spraying of powder material by the powder material feeding device, and the selective irradiation of areas of the layers by the irradiation device.

In a preferred embodiment of the apparatus, the control device is additionally coupled to the fiber holding arrangement, and the fiber holding arrangement is—as already mentioned as a possibility above—wholly or partially movable relative to the support device. A partial movability is present, for example, when a fiber holding arrangement is designed such that it is overall stationary with its center of gravity, but individual areas, parts, or components of the fiber holding arrangement are movable relative to one another. Furthermore, the control device is adapted to control, on the basis of data stored in the storage device that are part of the digital representation of an object and that describe the path, extension or orientation of a plurality of fibers in the object, the movement of the fiber holding arrangement in such a way that the corresponding fiber path, extension or orientation is obtained in the object.

It has likewise already been explained in detail above that the apparatus can, in these or other preferred embodiments, comprise a shaking or vibrating device or arrangement and/or an optical measurement device or arrangement. The control device is then preferably also connected to these devices and controls them in the manner described above.

It has likewise already been explained in detail above that, in these or other preferred embodiments, the at least one spray head can have a suitable device or arrangement, such as, for example, a high voltage electrode, that is connected or can be connected to a high voltage source, in order to electrically or electrostatically charge the powder material. The control device is then preferably also connected to this device and controls it in the manner described above.

### BRIEF DESCRIPTION OF THE DRAWINGS

A preferred embodiment of the disclosure herein is explained in greater detail below with reference to the drawings.

FIG. 1 shows a first exemplary embodiment of an apparatus for the production of a fiber-reinforced object.

FIG. 2 shows a second exemplary embodiment of an apparatus for the production of a fiber-reinforced object.

FIG. 3 shows the apparatus of FIG. 2 for the production of a fiber-reinforced object with a different fiber arrangement.

FIG. 4a illustrates the production of a fiber-reinforced object in the form of a metal-plastic hybrid component.

FIG. 4b illustrates another example of the production of a fiber-reinforced object in the form of a metal-plastic hybrid component.

### DETAILED DESCRIPTION

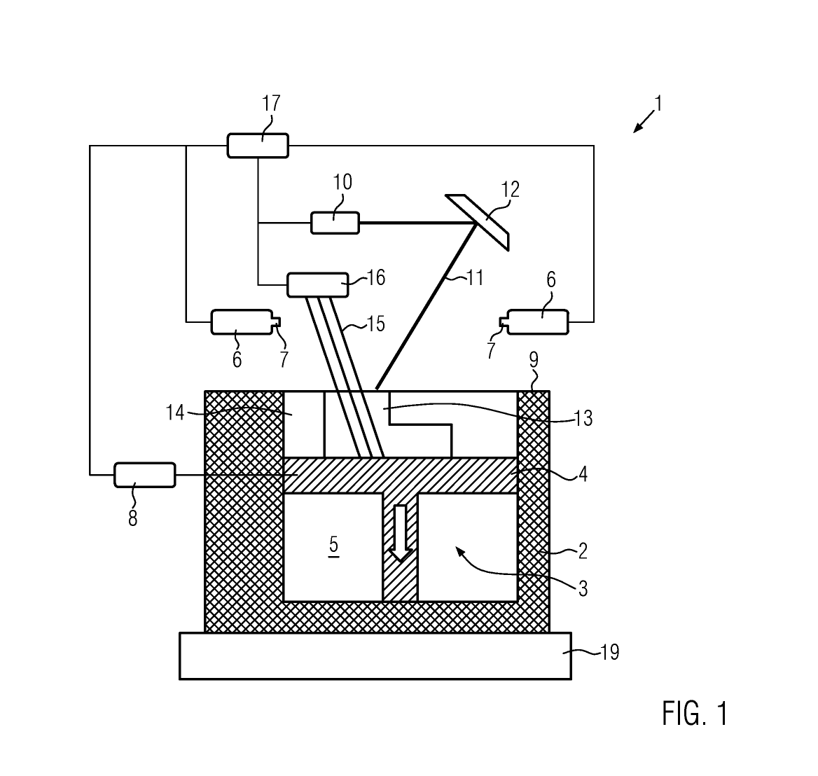

The apparatus 1 for selective laser melting (SLM) shown in FIG. 1 comprises a housing 2, in which a support device 3 is arranged, which in turn has a platform 4 which is movable in a vertical direction in an interior space 5 of the housing 2 open towards the top, which platform has a planar upper surface. The platform 4 sealingly engages the side walls of the interior space 5.

During operation, powder material is applied by two spray heads 6, which are at a distance from one another and arranged symmetrical relative to the platform 4, as a thin layer on the upper surface of the platform 4. For this purpose, the spray heads 6 each have a nozzle 7, which nozzles are orientated such that the powder material is applied from different directions to the platform 4. In order to ensure a uniform layer thickness over the full extension of the layer, the platform 4 is electrically charged by a charging device 8, which can be, for example, a suitable high voltage source connected to the platform 4, so that the powder material sprayed from the nozzles 7 is electrically attracted by the platform 4 and is thus uniformly deposited on the surface thereof.

In this regard, it may be provided that, prior to a spraying operation to apply a layer, the platform 4 is lowered in the interior space 5 so far that the vertical distance between the upper end 9 of the housing 2 and the upper surface of the platform 4 or of a partially produced object arranged on this platform is identical to the thickness of the powder material layer to be applied.

Once each powder material layer has been applied, a laser 10 is actuated to irradiate the layer by a laser beam 11. The laser beam 11 is moved by a movable reflector or mirror 12 over the layer, and the laser 10 and the reflector 12 are operated such that only selected areas of the layer are irradiated. In these areas, the powder material melts and forms a part 13, which corresponds to the respective layer, of a three-dimensional object.

After the irradiation of the layer, the above steps are repeated, i.e. the platform may be lowered by an interval that corresponds to the thickness of the subsequent layer, and the subsequent layer is applied by the spray heads 6 on top of the previous layer and then irradiated by the laser 10 and the reflector 12. The charging device 8 is preferably adapted to discharge the platform 4 after the application of each layer and prior to its solidification. The process is continued until the entire object 13 has been produced, which object is then situated in a bed 14 of non-solidified powder material.

Prior to the application of the first layer, a plurality of fibers 15 is attached, with one end in each case, to the upper surface of the platform 4. The fibers 15 are held at an opposite end by a movable fiber holding arrangement or device 16, which is arranged in each case such that the fibers 15 extend under tension from the upper surface of the platform 4 through a space region which corresponds to the object 13 to be manufactured. In this way, the fibers 15 are embedded in said object during the above described layer-by-layer construction of the object 13, so that the object 13 is a fiber-reinforced object. Due to the application of the layers by the spray heads 6 and the electrical attraction, the powder material can be applied with uniform layer thickness despite the presence of the fibers 15.

In this regard, it is possible for the position of the fiber holding device 16 to be selected differently for different layers such that the fibers 15 extend in different directions in different layers. For this purpose, the fiber holding device 16 is moved in a suitable manner.

The above process is carried out automatically under the control of a control device 17. For this purpose, the control device 17 is functionally connected to the charging device 8, the spray heads 6, the laser 10, the fiber holding device 16, and also to the reflector 12 and the platform 4 (the latter two connections are not shown in the Figures for image clarity reasons), so that the control device 17 can actuate, or operate, and move these devices or components in the described manner. The control is carried out on the basis of digital data that are stored in a storage device or memory of the control device 17. To produce a specific three-dimensional object, digital data are stored in the storage device which describe the structure of the object by layers, if appropriate including the fiber path, extension or orientation.

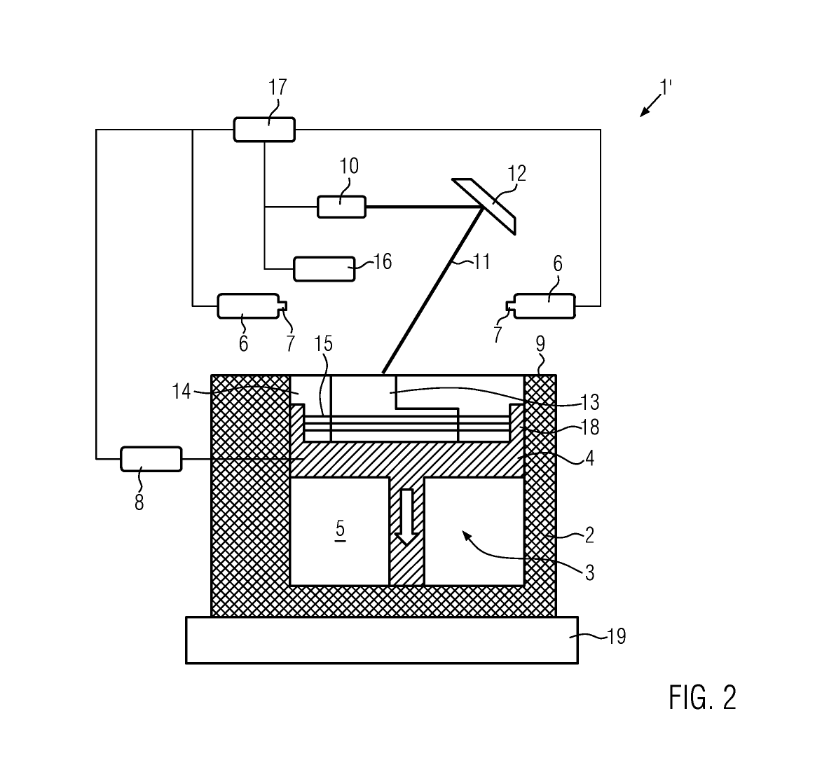

FIG. 2 shows an apparatus 1′ that is identical to the apparatus 1 of FIG. 1 except that a vertical wall 18 is provided at the edges of the upper surface of the platform 4. Unlike in FIG. 1, the fibers 15 are not tensioned between the upper surface of the platform 4 and the fiber holding device 16, but rather between two opposite portions of the wall 18. In this way, the object 13 is produced with a different fiber orientation.

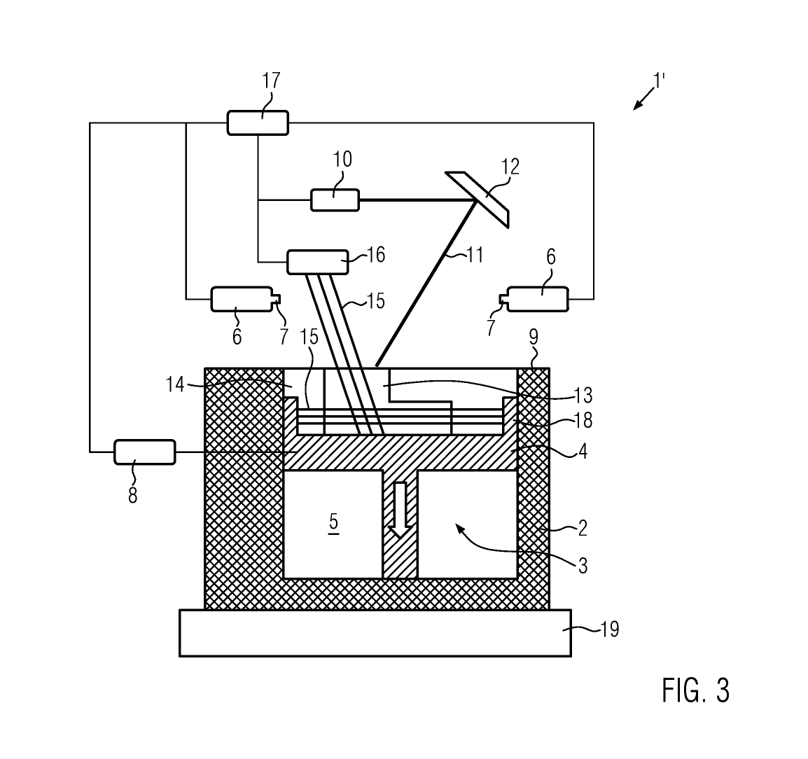

FIG. 3 shows the apparatus 1′, with fibers 15 having the orientation of FIG. 1 and also fibers 15 having the orientation of FIG. 2 being provided.

In each of the above exemplary embodiments, the housing can be coupled to a shaking or vibrating device 19, which is adapted to vibrate the platform 4 with an ultrasonic frequency. The shaking device 19 is likewise controlled by the control device 17 and this in such a way that the platform 4 is vibrated after the application of each layer in order to correct any remaining non-uniformity.

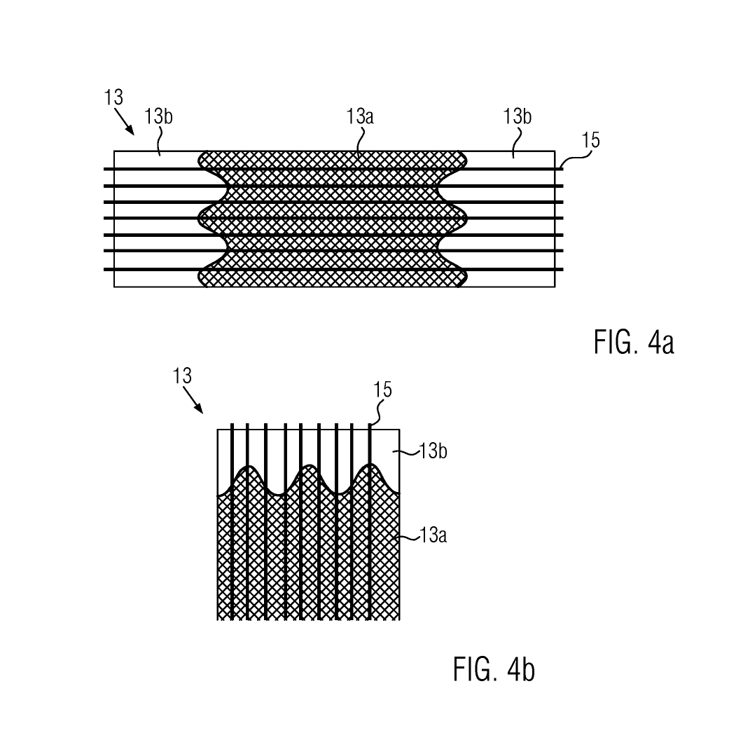

With the assistance of the explained apparatuses 1, 1′ and the corresponding explained method, it is also possible in a simple manner to produce an object 13 in the form of a fiber-reinforced metal-plastic hybrid component. Two corresponding objects 13 with different paths or orientations of the fibers are shown in FIGS. 4a and 4b. In this example, a thermoplastic material is used as the plastic. Because the melting point of metal is higher than that of thermoplastic material, at first a metal section or portion 13a of the object 13 is produced in the manner described above. Then the plastic portion 13b of the object 13 is produced—likewise in the manner described—directly on the already finished metal section or portion 13a. It may be necessary to change the object 13 during the production of different areas of the plastic portion 13b in order to be able to better realize the powder application. Something different may apply to the aforementioned stereolithography method which is also possible here, since the viscosity of the resin system already results in a uniform distribution and thus resin can be cured on all sides around the metal portion 13a. Irrespective of the method used for applying the plastic sections or portions 13b, it may be helpful to carry out a surface preparation or pre-treatment of the metal section or portion 13a, in order to improve or facilitate the adherence of the plastic layers. Such a surface treatment can comprise a combination of mechanical treatment or surface structuring (which is often not necessary, however, due to the already very rough surfaces in SLM processes) by, for example, milling, grinding, laser treatment, acid treatment and/or sandblasting for a macroscopic interlinking of the materials and an activation of the metal surface by, for example, atmospheric pressure plasma treatment, low-pressure plasma treatment, the SACO process (introduction of silicates by sandblasting) and/or ultrasound, or just one of these measures.

1. An additive layer manufacturing method for production of a three-dimensional fiber-reinforced object, wherein a plurality of layers of a powder material are applied successively and one on top of another on a support device and each layer is selectively irradiated, prior to application of a subsequent layer, by at least one laser beam or particle beam only in areas of the layer that correspond to the three-dimensional object to be produced, wherein the irradiation is carried out such that the powder material is locally melted or sintered in respective areas to solidify the layer in these areas, wherein
a plurality of fibers is provided, each of which fiber
is fixed with one end, prior to the application of the first layer or after the application of a part of the layers, to the support device or in one of the layers in the course of solidification thereof, and
is held by a fiber holding arrangement such that, at least in a portion extending from the fixed end, it extends through a space region in which one or more of the subsequent layers are applied and which corresponds to the three-dimensional object to be produced,
each of the layers is applied by spraying the powder material by at least one spray head, and
the support device is electrically charged and/or the powder material is electrically charged in the at least one spray head prior to the spraying, such that the powder material is electrically attracted by the support device.

2. The method according to claim 1, wherein
the support device is electrically charged prior to each application of a layer, and
the support device is discharged after each application of a layer and prior to or after solidification of this layer.

3. The method according to claim 1, wherein the support device is shaken or vibrated after each application of a layer and prior to the solidification thereof.

4. The method according to claim 3, wherein the support device is shaken or vibrated with a frequency from the ultrasonic range.

5. The method according to claim 1, wherein the powder material is sprayed, using two or more spray heads, from different directions relative to the support device.

6. The method according to claim 1, wherein, upon each application of a layer, the layer thickness is optically monitored and, on the basis of the monitoring, the application is controlled such that a predetermined layer thickness is obtained.

7. The method according to claim 1, wherein the support device is electrically charged differently in different areas, such that a different application of the powder material occurs in the different areas.

8. The method according to claim 1, wherein spatial orientation of the support device is changed such that, during the application of different layers, the support device has at least two different orientations.

9. The method according to claim 1, wherein the fiber holding arrangement and/or the at least one spray head is moved relative to the support device.

10. The method according to claim 1, wherein the selective irradiation of each layer takes place from different directions by several laser or particle beams.

11. The method according to claim 1, wherein the fibers are glass fibers, aramid fibers, carbon fibers, ceramic fibers and/or metal fibers.

12. The method according to claim 1, wherein the powder material includes powder from a metal or a metal alloy, powder from a plastic material, powder from a ceramic material and/or powder from a glass material.

13. An apparatus for production of a three-dimensional fiber-reinforced object using a method according to claim 1, which apparatus comprises:
a support device,
a powder material feeding device, which is adapted for applying the plurality of layers of a powder material to the support device, and which comprises the at least one spray head for spraying the powder material,
an irradiation device, which is adapted for irradiating each layer applied by the powder material feeding device prior to the application of the subsequent layer selectively and by areas using at least one laser beam or particle beam,
a charging device, which is adapted for selectively electrically charging and discharging the support device,
a fiber holding arrangement, which is adapted for holding a plurality of fibers, that are fixed with one end to the support device or in a layer of the object, in such a way that, at least in a portion extending from the fixed end, they each extend through a space region in which one or more of the subsequent layers are applied and which corresponds to a three-dimensional object to be produced,
a storage device for the storage of a digital representation of a three-dimensional object in the form of a plurality of layers, and
a control device, that is connected to the powder material feeding device, the irradiation device and the charging device and is adapted for controlling them such that a three-dimensional object, that corresponds to a digital representation of the object stored in the storage device, is produced in accordance with the method according to claim 1.

14. The apparatus according to claim 13, wherein the control device is additionally connected to the fiber holding arrangement, the fiber holding arrangement is wholly or partially movable relative to the support device, and the control device is adapted to control, on a basis of data stored in the storage device that are part of the digital representation of an object and that describe the path of a plurality of fibers in the object, the movement of the fiber holding arrangement in such a way that the corresponding fiber path in the object is obtained.
